(19) United States
(12) Patent Application Publication
(10) Pub. No.: US 2025/0085925 A1
(43) Pub. Date: Mar. 13, 2025

(54) SYSTEM EMULATION OF A FLOATING-POINT DOT PRODUCT OPERATION

(71) Applicant: Arm Limited, Cambridge (GB)

(72) Inventor: Christopher Gareth Mead, Cambridge (GB)

(21) Appl. No.: 18/243,778

(22) Filed: Sep. 8, 2023

(51) Int. Cl. G06F 7/544; G06F 5/01; G06F 7/02; G06F 7/485

(52) U.S. Cl. CPC G06F 7/5443; G06F 5/012; G06F 7/02; G06F 7/485

(57) ABSTRACT

System emulation of a floating-point dot product operation can be performed without directly performing the arithmetic by decomposing the Addend into a constituent sign, an exponent, and a fractional part; performing inverse scaling of the Addend by subtracting a scaling exponent (LSCALE) of a scaling of a negative power of two from the exponent to calculate an inverse-scaled addend; comparing a corresponding fractional part of the inverse-scaled addend with notional exponents of the most significant bit (MSB) and the least significant bit (LSB) of a fixed point accumulator to determine which of three cases have been encountered; and adding particular values representing the Addend to the calculation result according to which of the three cases have been encountered. The three cases include the inverse-scaled addend being able to be exactly accumulated into the fixed-point accumulator and the scenarios where the inverse-scaled addend is either too large or too small to be exactly accumulated into the fixed-point accumulator.

### BACKGROUND

As deep learning applications continue to improve, neural network model sizes and the compute resources needed to train them are increasing in size. For example, large natural language models, such as GPT-3, GPT-4, Turing-Megatron, PaLM, and OPT can take weeks to train on thousands of processors. To assist with deep learning training and inference acceleration, an 8-bit floating-point (FP8) binary interchange format has been proposed to take the place of the 16-bit formats common in modern processors. FP8 consists of two encodings—E4M3 (4-bit exponent and 3-bit mantissa) and E5M2 (5-bit exponent and 2-bit mantissa), where the common term “mantissa” is used as a synonym for IEEE 754 standard's trailing significand field (i.e., bits not including the implied leading 1 bit for normal floating-point numbers).

The FP8 format for software implementations of deep learning applications has been shown to accelerate and reduce resources required to train and simplifies 8-bit inference deployment. However, while it is possible to get more data through limited memory bandwidth, when performing certain arithmetic operations, such as a 4-way dot product, there is often a need for more than 32 bits of memory to capture the full numeric value. In addition, performing arbitrary precision arithmetic in software has a challenge due to most libraries being designed to use an unbounded amount of memory, which results in a large number of free store allocations to memory (i.e., the unallocated heap memory) and the split boundaries.

### BRIEF SUMMARY

System emulation of a floating-point dot product operation is described. A system emulator, which can be embodied as instructions stored on a computer-readable storage medium, can, when executed by a computing system, simulate the execution of an algorithm on a specific processor. The algorithm performs a floating-point (FP) dot product instruction that involves a sum of products calculation conducted with scaling by a negative power of two, combined with the addition of a FP Addend to the calculation result.

Advantageously, instead of performing all of the arithmetic directly for this FP dot product instruction, the addition of the FP Addend is performed by decomposing the FP Addend into a constituent sign, an exponent, and a fractional part: performing inverse scaling of the FP addend by subtracting a scaling exponent (LSCALE) of a scaling of a negative power of two from the exponent to calculate an inverse-scaled addend: comparing a corresponding fractional part of the inverse-scaled addend with notional exponents of the most significant bit (MSB) and the least significant bit (LSB) of the fixed point accumulator to determine which of three cases have been encountered; and adding particular values representing the FP Addend to the calculation result according to which of the three cases have been encountered. The three cases include the inverse-scaled addend being able to be exactly accumulated into the fixed-point accumulator and the scenarios where the inverse-scaled addend is either too large or too small to be exactly accumulated into the fixed-point accumulator. The methodologies described herein enable efficient performance of the FP dot product instruction when performed in software.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a method of emulating a floating-point dot product operation for a deep learning application.

FIG. 2 illustrates an example operating environment.

FIG. 3 illustrates a representation of a simulator program implementation of a system emulator that can perform the described floating-point dot product operation.

### DETAILED DESCRIPTION

System emulation of a floating-point dot product operation is described.

A system emulator is a software tool that simulates one or more specific system architectures. That is, a system emulator enables a particular system architecture (e.g., a “guest”) to be simulated on a host system so that applications designed for the guest can be run on the host. Such software tools are often referred to as simulators and emulators insofar as they provide a software-based implementation of a hardware architecture and include emulators, virtual machines, models, and binary translators, including dynamic binary translators.

One use of system emulators is for analyzing specific aspects of runtime behavior of a particular system architecture. This use of a system emulator is beneficial in development environments where the particular system architecture of interest is not present, for example when the actual hardware is not yet available.

For example, one type of system emulator is a software application that emulates a physical processor. In such an emulator, for each machine code instruction detected, actions semantically comparable to the source instructions are executed on the host processor. Thus, if one wants to emulate a particular instruction exactly in a simulator for validation purposes or for software checking, the emulator should match the numeric output of the hardware. An example system emulator is the FAST MODEL from ARM Limited.

Another type of system emulator is one that performs dynamic binary translation. Dynamic binary translation is a process of translating binaries (the machine code) from one instruction set architecture to another or within the same instruction set architecture. For example, the system emulator may include a simulation compiler that translates a target code into a host code.

A challenge when executing code in an emulator is that the operations can be inefficient compared to using real specialized hardware. Indeed, as mentioned above, there is often a need for more than 32 bits of memory to capture the full numeric value of certain calculations. In addition, performing arbitrary precision arithmetic in software has a challenge due to most libraries being designed to use an unbounded amount of memory, which can result in a large number of free store allocations to memory (i.e., the unallocated heap memory) and fragmentation of the free store.

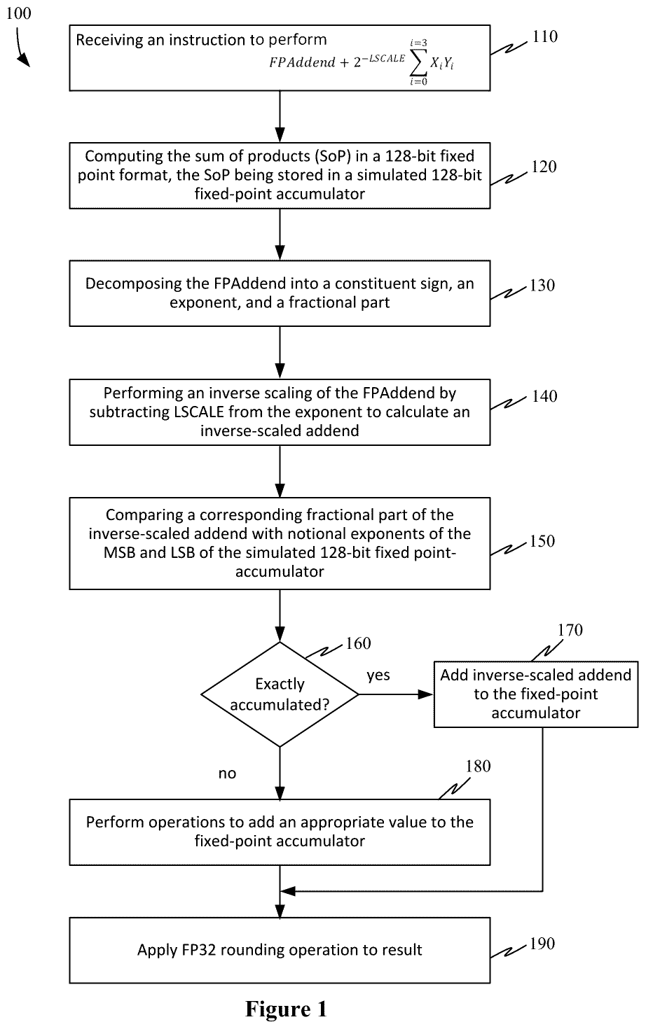

FIG. 1 illustrates a method of emulating a floating-point dot product operation for a deep learning application. Referring to FIG. 1, method 100 may begin upon receiving (110) an instruction to perform a FP dot product instruction that involves a sum of products calculation conducted with scaling by a negative power of two, combined with the addition of a floating-point (FP) Addend to the calculation result. In the illustrated scenario, the FP dot product instruction involves a four-way dot product calculation and the FP dot product instruction is given as

$$FPAddend + {2}^{- LSCALE} {\sum }_{i = 0}^{i = 3} {X}_{i} {Y}_{i} .$$

LSCALE is a piece of ambient state in the CPU that can be configured by software, for example, to set the range of numbers to be operated on, and stored in a register.

The FP Addend is a floating-point number in the IEEE standard FP32 format.

The product terms X, and Y, are the inputs to the sum of products operation. Although the illustrated scenario involves a sum of four products, the FP dot product can be a sum of two or more products. Indeed, the described techniques are applicable for a FP dot product with a narrower type and accumulation to a wider type (e.g., 8-bit 4× product to FP32). For deep learning applications, these product terms may be in the FP8 format. FP8 encoding details are specified in Table 1. The S.E.M notation is used to describe binary encodings in the table, where S is the sign bit, E is the exponent field (either 4 or 5 bits containing biased exponent), M is either a 3- or a 2-bit mantissa. Values with a 2 in the subscript are binary, otherwise they are decimal.

TABLE 1

| | E4M3 | E5M2 |
|---|---|---|
| Exponent bias | 7 | 15 |
| Infinities | N/A | S.11111.00₂ |
| NaN | S.1111.111₂ | S.11111.{01, 10, 11}₂ |
| Zeros | S.0000.000₂ | S.00000.00₂ |
| Max normal | S.1111.110₂ = 1.75 * 2⁸ = | S.11110.11₂ = 1.75 * 2¹⁵ = |
| | 448 | 57,344 |
| Min normal | S.0001.000₂ = 2⁻⁶ | S.00001.00₂ = 2⁻¹⁴ |
| Max subnorm | S.0000.111₂ = 0.875 * 2⁻⁶ | S.00000.11₂ = 0.75 * 2⁻¹⁴ |
| Min subnorm | S,0000.001₂ = 2⁻⁹ | S.00000.01₂ = 2⁻¹⁶ |

As mentioned above, instead of performing all of the arithmetic directly for this FP dot product instruction, the method 100 involves computing (120) the sum of products (SoP) in a fixed point format, where the SoP is stored in a simulated fixed-point accumulator having a first bit width of an appropriate size: decomposing (130) the FP Addend into a constituent sign, an exponent, and a fractional part: performing (140) inverse scaling of the FP addend by subtracting LSCALE from the exponent to calculate an inverse-scaled addend; and comparing (150) a corresponding fractional part of the inverse-scaled addend with notional exponents of the most significant bit (MSB) and the least significant bit (LSB) of the fixed point accumulator to determine (160) whether the inverse-scaled addend is able to be exactly accumulated into the fixed point accumulator.

In response to determining that the inverse-scaled addend is able to be exactly accumulated into the fixed-point accumulator, the method 100 includes adding (170) the inverse-scaled addend to the fixed-point accumulator. In response to determining that the inverse-scaled addend is not able to be exactly accumulated into the fixed-point accumulator, the method 100 includes performing (180) operations to add an appropriate value to the fixed-point accumulator. Once the result is obtained in the fixed-point accumulator, an FP rounding operation can be applied (190).

Upon receiving (110) the instruction to perform a FP dot product instruction, the method 100 can further include a pre-processing operation. The pre-processing can include detecting whether an input to the FP dot product instruction includes “not a number” (NaNs), Infinites, or always Zero results; and if the input includes NaNs, Infinites, or always zero results, an appropriate result is returned without continuing to the compute of the sum of products

In some cases, computing (120) the SoP in the fixed point format involves using a look-up table and accumulating each value obtained from the look-up table into the fixed-point accumulator using integer arithmetic. In some of such cases when the FP dot product is a sum of N FP8 products (where N is 2 or more and is bound by a size of the buffer/accumulator), computing the SoP includes concatenating the two FP8 numbers of each product of the sum of FP8 products to look up a corresponding 128-bit fixed point format of the product in the look-up table; and accumulating each value obtained from the look-up table into a 128-bit fixed-point accumulator using integer arithmetic. In some cases, computing (120) the SoP in the fixed point format is performed by computing the individual products algorithmically using integer arithmetic; and accumulating each computed product into the fixed-point accumulator using integer arithmetic. The fixed-point accumulator is able to be implemented as an emulated buffer of an appropriate size, for example, a 128-bit fixed point buffer can be implemented as two 64-bit words.

Once the SoP is computed, two trivial cases may be detected, causing subsequent steps (e.g., operations 130, 140 150, 160, 170, and 180) to be omitted. That is, if both the FP Addend and the exact SoP are 0, then 0 of the appropriate sign can be returned for the effective FP rounding mode (e.g., for operation 190): or if FP Addend is non-zero and the exact SoP is 0, the FP32 value of the FP Addend can be returned for the effective FP rounding mode (e.g., for operation 190).

Decomposing (130) the FP Addend into a constituent sign, an exponent, and a fractional part can be performed by any suitable sequence of operations using a processor's instruction set, for example, using bitwise and integer arithmetic, or in a higher level code (e.g., C). When decomposing (130) the FP32 value of the FP Addend, the FP Addend can be “renormalized” such that the mantissa/fractional part of the FP Addend is a 24-bit value with a leading 1 by definition.

Performing (140) inverse scaling of the FP addend by subtracting LSCALE from the exponent to calculate an inverse-scaled addend is possible in light of the following identity:

$$Addend + dscale \times SoP = dscale ( \frac{Addend}{dscale} + SoP ) , where dscale = {2}^{‐ LSCALE} .$$

As can be seen, by inverse scaling Addend before adding the Addend to the SoP, the Addend is able to be treated as being the same magnitude as that represented in the fixed-point accumulator.

As indicated above, once the inverse scaling is performed, the method includes comparing (150) the corresponding fractional part of the inverse-scaled addend with notional exponents of the MSB and the LSB of the SoP in the fixed point accumulator. In some cases, the MSB of the SoP can be obtained by performing a count-leading-zeros (CLZ) operation. The CLZ operation can be performed using host instructions where available or in software.

There are three cases that may be encountered when the comparing (150) of values and determining (160) whether the inverse-scaled addend is able to be exactly accumulated into the fixed point accumulator. The three cases include the inverse-scaled addend being able to be exactly accumulated into the fixed-point accumulator and the scenarios where the inverse-scaled addend is either too large or too small to be exactly accumulated into the fixed-point accumulator.

When the inverse-scaled addend is determined to be able to be exactly accumulated into the fixed-point accumulator, in addition to adding (170) the inverse-scaled addend to the fixed-point accumulator, the method 100 further includes extracting a corresponding sign, exponent, fractional part, round and sticky bits from the fixed-point accumulator; and scaling the result by adding LSCALE to the exponent. The “round” bit indicates the bit at ULP-1 of the fractional part and the “sticky” bit indicates whether any bits past ULP-1 of the fractional part are set (e.g., whether the value is exact or inexact). “ULP-1” refers to the unit in the last place/unit of least precision and is the spacing between two consecutive floating-point numbers (i.e., the distance from a value to the next representable value).

When the inverse-scaled addend is determined to be too large to be exactly accumulated into the fixed point accumulator and the constituent sign is the same sign as the SoP, performing (180) the operations to add appropriate value to the fixed-point accumulator can include: applying round=0 and sticky=1, and using the constituent sign, the fractional part, and the exponent of the FP Addend. This is possible because there exist interstitial 0s between the LSB of the FP Addend fraction and the MSB of the SoP. Thus, ULP-1 of the FP32 result is 0 and some lower bit is 1.

When the inverse-scaled addend is determined to be too large to be exactly accumulated into the fixed-point accumulator and the constituent sign is the opposite sign as the SoP, performing (180) the operations to add appropriate value to the fixed-point accumulator can include: subtracting 1 from the fractional part of the FP Addend, and applying round=1 and sticky=1. This is possible because the subtraction of the SoP ripples up through the interstitial 0s and flips the lowest 1-bit in the FP Addend fraction to 0, making all 0s below to 1. Thus, ULP-1 of the FP32 result is 1 and a lower bit is also 1.

When the inverse-scaled addend is determined to be too small to be exactly accumulated into the fixed point accumulator and the constituent sign is the same sign as the SoP, performing (180) the operations to add appropriate value to the fixed-point accumulator can include: extracting a corresponding sign, exponent, fractional part, round and sticky bits from the fixed-point accumulator, setting sticky=1, and adding LSCALE to the corresponding exponent extracted from the fixed-point accumulator. Sticky is set to 1 on the basis that some bit past ULP-1 of the fraction is 1 since FP Addend is non-zero.

When the inverse-scaled addend is determined to be too small to be exactly accumulated into the fixed point accumulator and the constituent sign is the opposite sign as the SoP, performing (180) the operations to add appropriate value to the fixed-point accumulator can include: decrementing the fixed-point accumulator by 1; extracting the corresponding sign, exponent, fractional part, round and sticky bits from the fixed-point accumulator; and adding LSCALE to the corresponding exponent extracted from the fixed-point accumulator. Decrementing the fixed-point accumulator by 1 is equivalent to subtracting 2-64 from SoP. This is equivalent to subtracting the smaller FP32 Addend as the subtraction ripples up through the interstitial 0s resulting in the lowest 1-bit in the fixed-point accumulator being set to 0 and all bits below set to 1.

A corner case of accumulating the Addend into the fixed-point accumulator can occur when the MSB of the Sum-Of-Products (SoP) is small. For example, when extracting the SoP from the fixed-point accumulator, there are 24-bits for the fraction. A corner case comes up where the MSB of the SoP is sufficiently small that the inverse scaled Addend overlaps both the bottom of the fixed-point accumulator and the bottom 24-bits of the fraction in the SoP. In this case, it is possible to truncate the Addend's fraction and accumulate it into the fixed-point buffer. This operation is safe because 1) The top bit of the Addend's 24-bit fraction must be 1; and 2) There are interstitial 0s between the LSB of the SoP (if there aren't then we could safely accumulate the full Addend without truncation anyway).

This means that the observable effects on the accumulator MSBs comprising the fraction and round bits (ULP-1) are correct. To take into account the effects of the truncated portion of the inverse-scaled Addend an analysis can be performed similar to that of Case 3 (where the inverse-scaled addend is too small), taking care to also handle the case where the truncated portion is 0.

To compute the final rounded result (e.g., operation 190), a rounding operation can be used that returns a rounded FP32 result and takes as inputs: the sign of the result, the exponent of the result, the top 24-bits of the fractional part of the result (includes “hidden” bit), a round bit, and a sticky bit from the fixed-point accumulator.

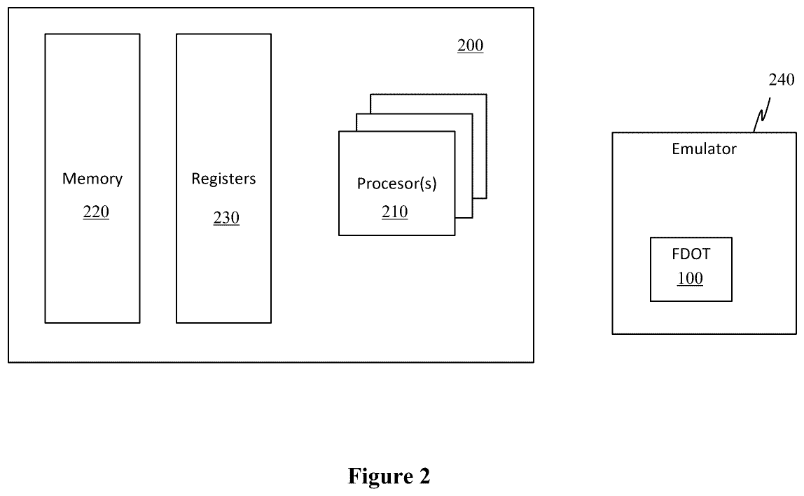

FIG. 2 illustrates an example operating environment. Referring to FIG. 2, a native host machine 200 includes native hardware components such as one or more processors 210, memory 220, and registers 230. The native hardware executes binaries created for the native architecture. The native host machine 200 further includes an emulator 240, which runs on the one or more processors 210, but fully simulates a particular processor executing a guest binary (e.g., a deep learning application running on a particular Arm processor while the native host machine may have Intel processor(s)). The guest binary can include one or more instructions for a FP dot product operation (FDOT) as described with respect to method 100 of FIG. 1.

For example, any application executing on the emulator 240 can perform a FP dot product operation including a calculation of a sum of products with scaling of a negative power of two combined with an addition of a FP Addend to a result of the calculation in software by: computing the sum of products (SoP) into an accumulator: decomposing the FP Addend into a constituent sign, an exponent, and a fractional part: performing inverse scaling of the FP addend by subtracting a scaling exponent (LSCALE) of a scaling of a negative power of two from the exponent to calculate an inverse-scaled addend: comparing a corresponding fractional part of the inverse-scaled addend with notional exponents of the most significant bit (MSB) and the least significant bit (LSB) of the accumulator to determine whether the inverse-scaled addend is able to be exactly accumulated into the accumulator: in response to determining that the inverse-scaled addend is able to be exactly accumulated into the accumulator, adding the inverse-scaled addend to the accumulator: in response to determining that the inverse-scaled addend is not able to be exactly accumulated into the accumulator, performing operations to add appropriate value to the accumulator: extracting a final sign, a final exponent, a final fractional part, a round bit, and a sticky bit from the accumulator; and performing a floating-point rounding operation using the extracted final sign, final exponent, final fractional part, round bit, and sticky bit from the accumulator to generate a final rounded result.

As described above, the FP dot product operation can be performed using a fixed-point accumulator, which can be implemented using a 128-bit buffer. For example, it can be observed that the largest and smallest possible 4-way sums of FP8 products are respectively:

4×E5M2_MAX*E5M2_MAX≈234

E5M2_MIN*E5M2_MIN≈2⁻³²

Numbers within this range can be represented exactly using a 67-bit fixed-point fraction. As such, the SoP can be computed in software by using a ˜67-bit fixed-point accumulator and a separate sign bit. A 128-bit buffer can thus be used to implement 128-bit fixed-point arithmetic where:
Bit-0 corresponds to 2⁻⁶⁴
Bit-127 corresponds to 2⁶³

While a 128-bit accumulator is larger than necessary for purely computing the SoP, the SoP can be implemented with a pair of 64-bit long words. This has the property that there is space to accommodate all 24 bits of an FP32 fraction (including hidden bit) where that might overlap or abut an SoP value.

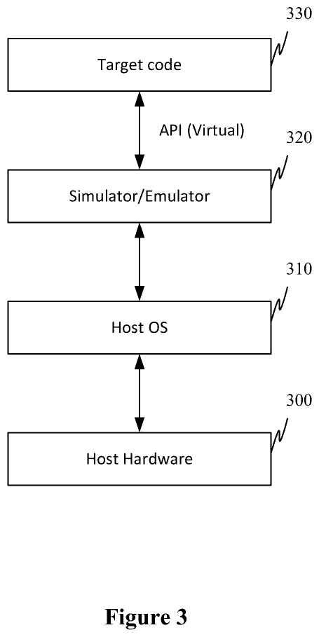

FIG. 3 illustrates a representation of a simulator program implementation of a system emulator that can perform the described floating-point dot product operation. Referring to FIG. 3, typically, a simulator implementation may run on a host processor 300, optionally running a host operating system 310, supporting the simulator program 320. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

In a simulated embodiment, equivalent functionality to particular hardware constructs or features may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of hardware elements are present on the host hardware (for example, host processor 300), some simulated embodiments may make use of the host hardware, where suitable.

The simulator program 320 may be stored on a computer-readable storage medium and provides a program interface (instruction execution environment) to the target code 330 (which may include a variety of applications, operating systems, and hypervisor) which is the same as the application program interface of the hardware architecture being modelled by the simulator program 320. Thus, the program instructions of the target code 330, including the FP dot product operation described above, may be executed from within the instruction execution environment using the simulator program 320, so that a host computer 300 which does not actually have certain hardware features can emulate these features.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as instructions, code, and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

1. A computer-readable storage medium having instructions stored thereon for a system emulator that when executed by a computing system directs the computing system to:
simulate execution of an algorithm on a particular processor comprising an accumulator having a first bit width, the algorithm performing a floating-point (FP) dot product instruction comprising a calculation of a sum of products with scaling of a negative power of two combined with an addition of a FP Addend to a result of the calculation, wherein the scaling of the negative power of two is given as 2^{-LSCALE}, wherein instructions to simulate the FP dot product instruction direct the computing system to:
compute the sum of products (SoP) in a fixed point format, where the SoP is stored in a simulated fixed-point accumulator having the first bit width;
decompose the FP Addend into a constituent sign, an exponent, and a fractional part;
perform inverse scaling of the FP addend by subtracting LSCALE from the exponent to calculate an inverse-scaled addend;
compare a corresponding fractional part of the inverse-scaled addend with notional exponents of the most significant bit (MSB) and the least significant bit (LSB) of the fixed-point accumulator to determine whether the inverse-scaled addend is able to be exactly accumulated into the fixed point accumulator; and
in response to determining that the inverse-scaled addend is able to be exactly accumulated into the fixed-point accumulator, add the inverse-scaled addend to the fixed point accumulator;
in response to determining that the inverse-scaled addend is not able to be exactly accumulated into the fixed-point accumulator, perform operations to add appropriate value to the fixed-point accumulator.

2. The computer-readable storage medium of claim 1, wherein the instructions to compare the corresponding fractional part of the inverse-scaled addend with notional exponents of the MSB and the LSB of the fixed-point accumulator determine that the inverse-scaled addend is too large to be exactly accumulated into the fixed-point accumulator.

3. The computer-readable storage medium of claim 2, wherein the constituent sign is a same sign as the SoP, wherein the instructions to perform operations to add appropriate value to the fixed-point accumulator direct the computing system to:
apply round=0 and sticky=1, and
use the constituent sign, the fractional part, and the exponent of the FP Addend.

4. The computer-readable storage medium of claim 2, wherein the constituent sign is an opposite sign as the SoP, wherein the instructions to perform operations to add appropriate value to the fixed-point accumulator direct the computing system to:
subtract 1 from the fractional part of the FP Addend, and
apply round=1 and sticky=1.

5. The computer-readable storage medium of claim 1, wherein the instructions to compare the corresponding fractional part of the inverse-scaled addend with notional exponents of the MSB and the LSB of the fixed point accumulator determine that the inverse-scaled addend is too small to be exactly accumulated into the fixed-point accumulator.

6. The computer-readable storage medium of claim 5, wherein the constituent sign is a same sign as the SoP, wherein the instructions to perform operations to add appropriate value to the fixed-point accumulator direct the computing system to:
extract a corresponding sign, exponent, fractional part, round and sticky bits from the fixed-point accumulator;
set sticky=1; and
add LSCALE to the corresponding exponent extracted from the fixed-point accumulator.

7. The computer-readable storage medium of claim 5, wherein the constituent sign is an opposite sign as the SoP, wherein the instructions to perform operations to add appropriate value to the fixed-point accumulator direct the computing system to:
decrement the fixed-point accumulator by 1;
extract the corresponding sign, exponent, fractional part, round and sticky bits from the fixed-point accumulator; and
add LSCALE to the corresponding exponent extracted from the fixed-point accumulator.

8. The computer-readable storage medium of claim 1, wherein in response to determining that the inverse-scaled addend is able to be exactly accumulated into the fixed-point accumulator, the instructions further direct the system to:
after accumulating the inverse-scaled addend exactly into the accumulator, extract a corresponding sign, exponent, fractional part, round and sticky bits from the fixed-point accumulator; and
scale the result by adding LSCALE to the exponent.

9. The computer-readable storage medium of claim 1, wherein the instructions to: compute the SoP in the fixed point format direct the computing system to compute the SoP in the fixed point format using a look-up table and accumulating each value obtained from the look-up table into the fixed-point accumulator using integer arithmetic.

10. The computer-readable storage medium of claim 1, wherein the sum of products is a sum of four FP8 products, the FP8 being an 8-bit floating-point binary interchange format.

11. The computer-readable storage medium of claim 10, wherein the instructions to: compute the SoP in the fixed point format direct the computing system to:
concatenate the two FP8 numbers of each product of the sum of four FP8 products and look up a corresponding 128-bit fixed point format of the product in a look-up table; and
accumulate each value obtained from the look-up table into the fixed-point accumulator using integer arithmetic.

12. The computer-readable storage medium of claim 1, wherein a final value in the fixed-point accumulator is converted to a 32 bit floating-point number and rounded.

13. The computer-readable storage medium of claim 1, wherein the emulator comprises instructions of a function which extracts a sign, exponent, top 24-bits of a fractional part, a round bit, and a sticky bit from a storage location.

14. The computer-readable storage medium of claim 1, wherein the emulator comprises instructions to perform a count-leading-zeros (CLZ) operation to extract a sign, exponent, top 24-bits of a fractional part, a round bit, and a sticky bit from the fixed-point accumulator.

15. The computer-readable storage medium of claim 1, wherein instructions to simulate the FP dot product instruction further direct the computing system to:
detect whether an input to the FP dot product instruction includes “not a number” (NaNs), Infinites, or always Zero results; and
if the input includes NaNs, Infinites, or always zero results, return an appropriate result without continuing to the compute of the sum of products.

16. A method of performing a floating-point (FP) dot product operation comprising a calculation of a sum of products with scaling of a negative power of two combined with an addition of a FP Addend to a result of the calculation in software, the method comprising:
computing the sum of products (SoP) into an accumulator;
decomposing the FP Addend into a constituent sign, an exponent, and a fractional part;
performing inverse scaling of the FP addend by subtracting a scaling exponent (LSCALE) of a scaling of a negative power of two from the exponent to calculate an inverse-scaled addend;
comparing a corresponding fractional part of the inverse-scaled addend with notional exponents of the most significant bit (MSB) and the least significant bit (LSB) of the accumulator to determine whether the inverse-scaled addend is able to be exactly accumulated into the accumulator;
in response to determining that the inverse-scaled addend is able to be exactly accumulated into the accumulator, adding the inverse-scaled addend to the accumulator;
in response to determining that the inverse-scaled addend is not able to be exactly accumulated into the accumulator, performing operations to add appropriate value to the accumulator;
extracting a final sign, a final exponent, a final fractional part, a round bit, and a sticky bit from the accumulator; and
performing a floating-point rounding operation using the extracted final sign, final exponent, final fractional part, round bit, and sticky bit from the accumulator to generate a final rounded result.

17. The method of claim 16, wherein the method is performed during execution of a deep learning algorithm.

18. The method of claim 16, wherein the method is performed during dynamic binary translation.

19. The method of claim 16, wherein comparing the corresponding fractional part of the inverse-scaled addend with notional exponents of the MSB and the LSB from the accumulator comprises:
determining that the inverse-scaled addend is too large to be exactly accumulated into the accumulator; and
if the constituent sign is a same sign as the SoP, performing operations to add appropriate value to the accumulator comprises:
applying round=0 and sticky=1, and
using the constituent sign, the fractional part, and the exponent of the FP Addend; and
if the constituent sign is an opposite sign as the SoP, performing operations to add appropriate value to the accumulator comprises:
subtracting 1 from the fractional part of the FP Addend, and
applying round=1 and sticky=1.

20. The computer-readable storage medium of claim 1, wherein comparing the corresponding fractional part of the inverse-scaled addend with notional exponents of the MSB and the LSB from the accumulator comprises:
determining that the inverse-scaled addend is too small to be exactly accumulated into the accumulator; and
if the constituent sign is a same sign as the SoP, performing operations to add appropriate value to the accumulator comprises:
extracting a corresponding sign, exponent, fractional part, round and sticky bits from the accumulator;
setting sticky=1; and
adding LSCALE to the corresponding exponent extracted from the accumulator; and
if the constituent sign is an opposite sign as the SoP, performing operations to add appropriate value to the accumulator comprises:
decrementing the fixed-point accumulator by 1;
extracting the corresponding sign, exponent, fractional part, round and sticky bits from the accumulator; and
adding LSCALE to the corresponding exponent extracted from the accumulator.
